(19) United States
(12) Patent Application Publication
(10) Pub. No.: US 2012/0150658 A1
(43) Pub. Date: Jun. 14, 2012

(54) Systems, Methods and Apparatus for Valuation and Tailoring of Advertising

(76) Inventor: Daniel Raymond Swanson, SR., Midlothian, VA (US)

(21) Appl. No.: 13/323,604

(22) Filed: Dec. 12, 2011

Related U.S. Application Data
(63) Continuation of application No. 12/315,688, filed on Dec. 5, 2008.

(51) Int. Cl. G06Q 30/02; G06F 17/30

(52) U.S. Cl. 705/14.66; 707/737; 707/E17.046

(57) ABSTRACT

A system and method classifies advertising based on referencable attributes. An individual advertisement is classified by predefined referencable attributes. The advertisement and the predefined referencable attributes are linked using alphanumeric or digital codes. The advertisement and the linked codes are stored such that the advertisement and linked codes are accessible by a user.

### RELATED APPLICATION

This application is a continuation of U.S. patent application Ser. No. 12/315,688, filed on Dec. 5, 2008, which is incorporated herein by reference in its entirety.

### BACKGROUND

Traditionally advertising has been a “Push” type of communication. Where the advertising consumer or end user experiences advertisements that others have selected for the user. As a result, modern consumers often view advertising as something that impedes them from experiencing the actual content selected by the user. More and more users are pressing the mute button on remote controls to stop at least the sound component of the advertising content. Sometimes, users will switch channels during advertisement to avoid advertisements. This means the content provider and the advertiser lose the consumer's attention. This has led to the current state of affairs where advertising is losing its ability to influence consumers.

Conversely, these very same consumers generally have information needs that can be served by advertising. Consumers will pay close attention to advertisements that interest them. Sometimes consumers will even stop what they are doing to ensure that they see or hear an advertisement that interests them. Unfortunately, today consumers do not have a convenient mechanism to enable them to experience the advertisement in which they truly have interest.

Traditionally, radio, television and internet content have been provided to users at little or no cost. The cost of much of the content is paid by advertisers who are allowed to insert messages inside the program that is provided to the user. Content providers, advertising agencies and advertisers track group data such as demographics, to try to understand whether or not an intended advertising target was reached by the advertising. At best, the content provider could tell the advertiser that an advertisement was broadcast at a certain time and that the program had, for example, 35,000 20-25 year olds in the audience at the time. The advertiser does not know how many of the 20-25 year olds actually watched the advertisement. Nor does the advertiser or the content provider know how many of the 20-25 year olds are interested in buying the product or service as a result of the advertisement.

In other instances, content is provided for a fee. Generally, the user pays a subscription fee for one time, daily, monthly or annual access to the content. This can be costly for a customer, especially if the customer is only interested in one or two programs during the month and the subscription fee requires an entire month's payment.

From the advertiser's standpoint mass advertising can be very costly and even wasteful. Traditionally, mass market advertising is designed to reach a very wide group of people, even though advertisers know only a few people will actually buy the product or service offered by the advertiser. As a result, advertisers routinely make large buys of advertising hoping that some, perhaps only a small fraction; of the exposures will lead a user to buy the advertiser's product or service.

Part of the problem with mass advertising occurs because individual advertisements are inserted into content before the content leaves the content provider. This can be easily seen in newspapers, where both news stories and advertisements are preprinted before delivery. Magazine publishers follow a similar process to combine advertisements and content before printing. Radio and Television providers place advertisements within content prior to broadcasting the program. Because of the method by which content and advertising are combined, mass advertising content reaches a much larger audience than those users who are likely to purchase an advertiser's product or service. This is wasteful for the advertiser.

The internet may be able to provide tailored advertisements to a certain extent. Once again these efforts are often tailored not to the individual as much as tailored to the group. Even with this increased ability to tailor advertisements to a group, a disadvantage exists because the internet is costly for many consumers. To function, the internet requires a computer, or some other specialized access device. In addition, many full motion video advertisements require a large bandwidth to properly display. Obtaining an internet provider and a large bandwidth can add even more cost to consumers. It is common for such costs to be in excess of hundreds of dollars a year for a service that provides large bandwidth. Before a consumer can even view content and advertisements a substantial investment must be made.

Previously, advertisers and others have tried to refine their advertising strategies to reach more accurately targeted potential customers. But these efforts have had limited success. Most of this refinement has come by placing more emphasis on segmentation models that use demographics and psychographics to place customers in groups of similar individuals. Some of these methods of data gathering get to the household level of detail. Consumers often do not grant permission for the gathering of information at this level of detail. As a result, this data may be gathered without their permission. Consequently, consumers may feel anxiety and stress because of this method's perceived intrusiveness and perceived violation of privacy. U.S. Pat. No. 7,370,073 discloses a method for using set top boxes to track users viewing habits, and generate viewer profiles. This method may increase consumer anxiety by creating a “big-brother is watching” perception during a time when people should feel safe; when they are privately watching television in their own home.

U.S. Pat. No. 6,718,551 also discloses a method of targeting advertisements to television viewers, by casting individuals into groups of similar consumers. When an advertisement is scheduled in a program, these segment groups are then redirected “from the continuous broadcast program to a channel running an advertisement”. In this manner the method described in U.S. Pat. No. 6,718,551 targets advertisements to groups of similar customers. This method, like methods identified above, presents advertisement to groups of individuals who share similar characteristics.

Currently, because television and radio advertisement are not tailored to the individual, users lack interest in the ads. Consumers frequently switch between channels when an advertisement appears. It is quite common for users to watch two or more programs simultaneously on different channels; switching from one channel to the next whenever an advertisement appears. This further decreases the value of an advertisement. Advertisers frequently buy ad time on multiple channels during the same time slot to increase the probability that a channel switching customer will somehow see their advertisement.

### BRIEF DESCRIPTION OF THE DRAWINGS

FIG. 1 illustrates a system environment in accordance with an example embodiment;

FIG. 2 illustrates an illustrative example of traditional advertisement insertion in a single television program that is provided for contrast;

FIG. 3 illustrates an embodiment of an example system that shows a plurality of user inputs;

FIG. 4 illustrates a block diagram for creating tailored advertisement output;

FIG. 5 illustrates an example advertisement valuation, placement, and measurement system;

FIG. 6 illustrates an example process for classifying an advertisement;

FIG. 7 illustrates an example table that may be used for the classification and valuation of an advertisement.

FIG. 8A illustrates an example user initiated advertisement preference and valuation process;

FIG. 8B illustrates an example advertisement valuation process;

FIG. 9 illustrates an example user selection and valuation example;

FIG. 10 illustrates an example ad placement module;

FIG. 11 is a schematic diagram which illustrates example placement of advertisement in a high value content program using the ad placement module;

FIG. 12 is a schematic diagram which illustrates example placement of advertisement in a lower value content program using the ad placement module;

FIG. 13 is a schematic diagram which illustrates example valuation and categorization of an advertisement based on individualized valuations of the advertisement;

FIG. 14 is a schematic diagram which illustrates example placement of an advertisement by two different users at differing locations within identical content, based on individualized valuations of the advertisement;

FIG. 15 is a process flow diagram which illustrates an overview of the tailored placement of an advertisement;

FIG. 16 shows a process flow diagram for an example method of creating a customer generated advertisement rating;

FIG. 17 shows a process flow diagram for an example method of consolidating a customer generated advertisement preference output;

FIG. 18 shows a process flow diagram for an example method of creating portability of customer generated advertisement preferences; and

FIG. 19 is a block diagram of a computer system for executing methods of various embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of wired or wireless transmissions. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system. The software may be executed on a plurality of digital signal processors.

Various embodiments relate to the valuation and personalization of advertisements that are placed within media content including, but not limited to, sound or visual image, music, motion pictures, radio and television broadcasting. More particularly, the invention relates to apparatus, systems and methods for identifying, valuing, placing into content, rating, measuring and reporting on advertisements in media content. The present invention may also be used to provide accounting information and feedback to advertisers, or other interested parties, on the advertising.

Individual consumers are willing to watch advertisements for products and services that are of interest to them. Consumers have been known to seek out websites to see internet versions of advertisements that are interesting to them. Traditional mass market advertising does not adequately provide for individual customers with individual needs.

Presently there is no known way for an advertisement to be valued and tailored to an individual content user's preferences in a manner that will increase the willingness of the user to view the advertisement, Likewise, there is no known way for an advertisement to be valued and tailored to an individual content user's preferences in a manner that will value the advertisement and also provide feedback to advertisers on the efficiency and effectiveness of their advertising effort. There is no known way of bringing all of these important components together and at the same time pay for content so users may view the content at little or no cost to the user.

Successful, efficient advertising benefits both the advertiser, and the consumer. With efficient advertising the advertiser reaches consumers that are interested in buying the advertised product or service. The consumer benefits by being able to effectively find products or services that are valuable to them as individuals. Advertising helps solve consumer problems by making the consumer aware of products or services that may improve the consumer's life. In addition, because of advertising, the consumer is able to receive content at little or no cost.

A method and apparatus provides valuation and tailoring of advertisements to individuals over a networked media delivery system. Broadly stated, the invention allows a user to specify properties of advertisements that are of interest to said user. These user defined properties may be combined with inputs from the content provider and the advertiser to determine the value of an advertisement. The now valued advertisement is intelligently categorized and delivered into program content as appropriate. Systems and methods for valuing and tailoring advertisements and the placing said advertisements into media content as a result of the valuation are provided. Further, various embodiments provide valuable feedback to advertisers and content providers by identifying important opportunities for advertising and potential valuations of current and future advertisements.

Some embodiments may deliver different advertisements to different users who are viewing (or using) the same content at the same time. Such content may be referred to as mass content. In addition, the present invention can deliver the same advertisement to different users at different time periods (i.e. advertising slots) during the same program. Because the present invention uses individual valuations for advertisements, there is almost no limit to the potential combination of users, advertisements, advertising slots and even programs that can be effectively serviced by the invention.

In one embodiment, a plurality of inputs is brought together with a communication network into an advertising tailoring system. Using these inputs, a valuation is calculated for each advertisement, the advertisements are categorized by calculated value and are then stored either locally or remotely to the user's output device, as content is delivered to the device, the advertising tailoring system selects and places appropriately valued advertisements in appropriate advertising slots in the content. Results of advertisement placement are then gathered, reported and consolidated to document the advertisement's reach and potential impact. This information may then be shared with advertisers, content providers, and users. Various embodiments are designed to help ensure users will receive advertisements that are valuable to them and at the same time, advertisers will know that their advertisements are reaching potential customers instead of merely the mass market.

Such tailored advertising may include, but is not limited to, television, radio, game system advertising, cellular phone advertising, email advertising, and internet advertising and potentially any advertising method where an individual is the consumer of the advertisement.

Further features and potential advantages as well as the structure of operation of various embodiments are described in the following text which includes detailed descriptions and figures.

It is to be understood that both the foregoing general descriptions and the following detailed description are examples and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

A description of the various embodiments follows. As an overview, embodiments of the systems and methods for user and advertiser valuation and tailoring of advertising consistent with the present invention take inputs from one or a plurality of sources. These inputs are used to determine an appropriate valuation of the advertisement for the individual user. This valuation may then be used to categorize the advertisement into one or a plurality of valuation groups. As content is delivered to the user, advertisements from the valuation groups are placed in the content at appropriate points. The result of this tailored advertisement placement is gathered, processed and stored to facilitate reporting to advertisers, content providers or even users. Personally identifiable information such as name, address, age, sex, additional channels viewed and other information, in one embodiment, may only be gathered and reported if a user voluntarily agrees to attach this information. The user may volunteer this information as a part of their desire to have contact from an advertiser, or for some other personal reason the user may have.

The system can be implemented over a variety of multimedia networks with large populations of network devices including but not limited to: televisions, television cable, satellite and set top boxes, game consoles, cell phones, portable data access devices, email, computers, radio, and other network apparatus or appliances.

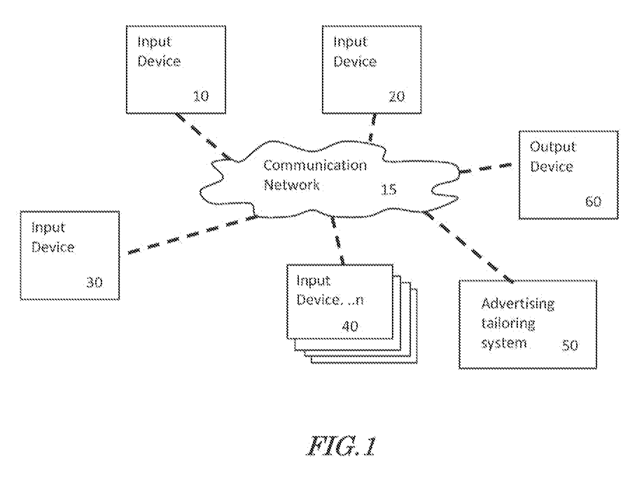

FIG. 1 illustrates an example communication network that allows for a plurality of input devices to communicate. Such a network may be a wired network or a wireless network. Input device 10 may be a laptop or desktop computer that enables a user to make advertisement preference selections. Input device 20 may be one or a plurality of content providers that supply content. Communication Network 15 enables a plurality of input devices to communicate. Input device 30 may be one or a plurality of advertisement providers. Input device 40 represents a plurality of additional possible input devices, which include but are not limited to, television or set-top TV box remote controls, satellite remote controls, cell phones, telephones, Personal Digital Assistants, or any other wireless or wired device that has the ability to make selections and link to a network. Advertising tailoring system 50 gathers information from one or a plurality of input devices, calculates a valuation for an advertisement, identifies necessary values needed in a content program and then selectively places advertisements within the content received at an appropriate advertising spot. The placement of the advertisement is recorded. Metrics on the advertisements placement are reported as appropriate. Output device 60 is the device by which the content and advertisement is experienced (i.e. viewed for television, heard for radio etc.) within the program. Computers are more and more being used as such output devices.

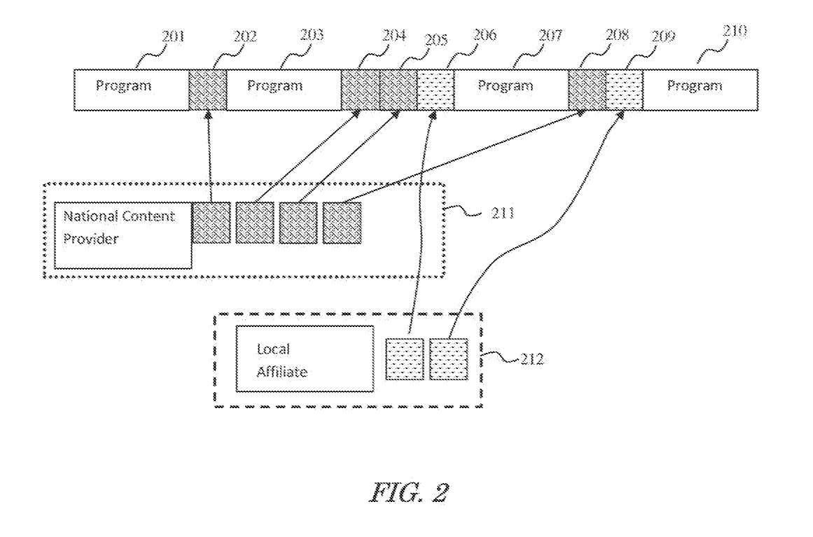

FIG. 2 is an illustrative example of a television program with designated commercial breaks which is provided for comparison to clearly exemplify the differences between the embodiments and traditional broadcast television. 201 is the opening segment of the program content usually designed to “catch” or “hook” an audience before the first commercial. 202 is the first advertisement that is placed within the program. Traditionally this is often placed by the national content provider 211. This may be a single advertisement as shown in FIG. 2 or it may be a block of advertisements. Advertisements are often produced outside of the national content provider and delivered to 211 by an advertising agency or other advertisement producer (not shown in FIG. 2). Engineers at 211 are then able to assemble advertisements for broadcasting in advance of the program broadcast time. Generally, each advertisement location is identified by both time code and by a queue (sometimes called q-tone) built into the program. This allows program engineers to ensure that commercials are run at appropriate times within a program. 203 is the second program content segment that follows the first commercial break. 204 is the second commercial inserted from the national content provider. 205 is the third commercial inserted from the national content provider 211. 206 is the first commercial that is inserted by the local affiliate 212 of the national content provider. Because many users “tune out” of programs after the first few minutes of a program due to lack of interest, and partially because they do not reach a national audience, local affiliate advertisements often sell for much less that national advertisements. 207 represents the program that follows after the second commercial break. 208 is the final national content provider advertisement to be placed within the program. 209 is the final local affiliate advertisement inserted into the program content. 210 represents the final program segment broadcast to the user in our example.

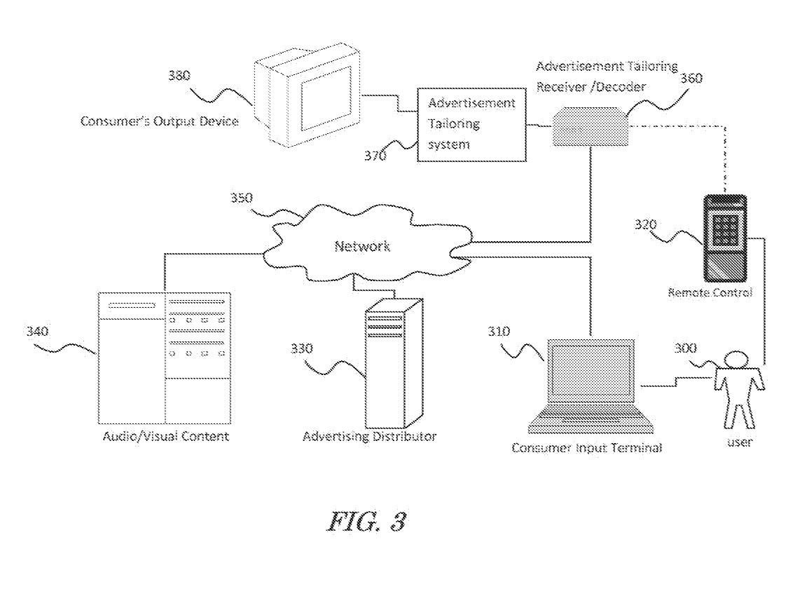

FIG. 3 is illustrative of an embodiment in the medium of broadcast television. User 300 represents a system user or consumer of broadcast television programming. Consumer Input Terminal 310 represents a device that a consumer may use to make his individualized selections on advertising preferences. Remote Control device 320 may enable a user to make selections from a menu that is displayed directly on the TV or on another device such as Advertisement Tailoring Receiver/Decoder 360. Remote Control 320 may be a traditional television, cable TV, or satellite remote control. In further embodiments, device 320 may be a cell phone, computer, laptop computer, digital assistant or similar combination of cell phone, computer, organizer, etc., or even a game controller which has the ability to link to a network and allow a User 300 to make selections and with some devices view programming. Remote Control 320 may be used to input a family member code number to identify which family member viewing a program or will be experiencing the content. For example, in one embodiment, a husband typing a 1 into the remote control indicates that he is the family member who is primarily interested in the content. (His wife may type a 2, the oldest daughter a 3, the oldest son a 4 etc.). In another embodiment, identification of viewing individuals is made through the use of a face recognition apparatus built into the television or computer itself. In another embodiment, identification of viewing individuals is made through a face recognition apparatus that is built into the set-top box unit. The face recognition apparatus may be built into the Advertisement Tailoring Receiver/Decoder 360. Remote Control 320 may also be used to rate the advertisement after it is displayed on Consumer Output Device 380. Both Consumer Input Terminal 310 and Remote Control 320 are shown linked to Network 350. This network may be a wireless network or a wired network. Network 350 may be a public network such as the internet, (worldwide web), or a semi-private or private network such as a home network, a hard wired network such as a telephone network, a fiber optic network, a cable network or a satellite network to name a few.

Advertising Distributor 330 may be an advertising agency, it may be a manufacturer or a service provider, and it may be even be a part of the content provider. Though Advertising Distributor 330 and Audio/Visual Content 340 are shown in FIG. 3 as distinct from one another, they could be in the same company, same location and even on the same server, piece of hardware, or even on the same processor or same plurality of processors. Audio/Visual Content 340 represents the content that is provided to the network. For example, Audio/Visual Content 340 may come from one of the traditional networks such as ABC, NBC, CBS or Fox. Audio/Visual Content 340 may also come from any other cable, satellite, broadcasting, local or national provider. Audio/Visual Content 340 may also be received from a number of sources simultaneously.

Advertisement Tailoring Receiver/Decoder 360 receives inputs from the network and may directly receive input from Remote Control 320. While Advertisement Tailoring Receiver/Decoder 360 may be contained in set-top box, Advertisement Tailoring Receiver/Decoder 360 may also be integrated into the Advertisement Tailoring System 370. Either or both Advertisement Tailoring Receiver/Decoder 360 and Advertisement Tailoring System 370 may be integrated into Consumer's Output Device 380 such as a television set in the case of broadcast, cable or satellite television. Either or both Advertisement Tailoring Receiver/Decoder 360 and Advertisement Tailoring System 370 may also be integrated into a radio set in the case of broadcast, cable or satellite radio. For a computer embodiment, either or both Advertisement Tailoring Receiver/Decoder 360 and Advertisement Tailoring System 370 may be separate apparatus or either or both may be integrated into the computer display terminal, the computer motherboard, the computer hard drive, the computer's Random Access Memory (RAM), the computer's fixed or removable storage memory, or any other future means by which a computer may store and process the information necessary for and Advertisement Tailoring System 370 to complete its tasks. For the game console embodiment, either or both Advertisement Tailoring Receiver/Decoder 360 and Advertisement Tailoring System 370 may be separate apparatus or either or both 360 and 370 may be integrated into the game console itself, in a similar manner as the integration into the computer as described above. For both land line phones and cellular phones, the various embodiments may include integrating Advertisement Tailoring Receiver/Decoder 360 and Advertisement Tailoring System 370 directly in the phone receiver or handset.

Consumer Output Device 380 is the consumer's output device where both the content and the tailored advertisement may be seamlessly presented. FIG. 3 shows a television set for Consumer Output Device 380 this is not meant to be exclusionary of other output devices. For a radio embodiment, Consumer Output Device 380 could be a radio receiver. For the computer embodiment, Consumer Output Device 380 may be a separate computer model, or in the case of a laptop, PDA, or tablet, or hand held personal computer Consumer Output Device 380 may be the built in display. In the instance of a person using a computer with an extended desktop (i.e. one application window on a connected but stand-alone monitor and another application on the laptop display) one embodiment may include running both program content and advertisement on either the laptop display or on the monitor. In further embodiments a user may want to split advertisements to one display output device and run content on the other display output devise. Content and advertisement may be split in some embodiments. For the game console embodiment Consumer Output Device 380 may be the standard output device. But as with the computer embodiment other potential output displays are envisioned. For the phone embodiment, Consumer Output Device 380 may be a standard display device that is part of the cell phone.

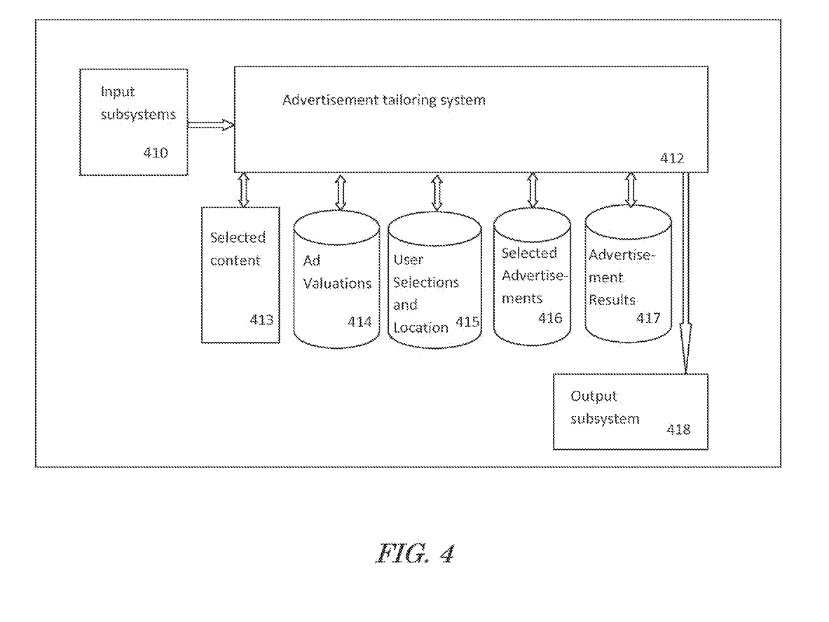

FIG. 4 illustrates the components used by the Advertisement tailoring system 412. Input Subsystems 410 may be at least one of the following, a keyboard, a website, a remote control device, a broadcast signal, a satellite feed, a cable TV feed, a Virtual Private Network (VPN), a Bluetooth device, a personal digital assistant PDA, a Voice activated response (VAR) system, Voice Response unit (VRU), a cellular or mobile phone voice system, a cellular or mobile phone Short Message Service (SMS) system,.

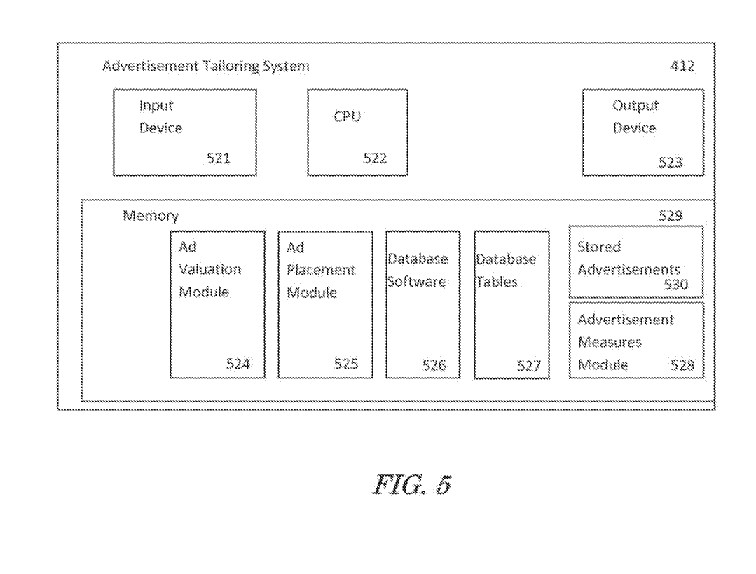

These inputs may come from diverse and even encrypted sources. Advertisement tailoring system 412 decodes them into a format usable by the advertisement tailoring system 412. The advertisement tailoring system 412 values the advertisement using the Ad Valuation Module 524 (FIG. 5A-5B), and places the advertisement appropriately using Ad Placement Module 525 FIGS. 5A and 5B. This placement occurs when selected content is received and as it is being presented to output subsystems 418.

The Advertisement tailoring system 412 uses information from Ad Valuations 414, and User Selections and Location 415, to populate Selected Advertisements 416 with appropriate advertisements that will be placed in appropriate locations within the content.

Advertisement tailoring system 412 receives Selected Content 413. During content distribution, as Advertisement tailoring system 412 places the advertisement in content, the placement is captured in Advertisement Results 417, along with any rating the user may give the advertisement through the remote control interface as described in FIG. 3 using remote control 320. In addition, ratings of viewed advertisement may also be added using FIG. 3 consumer input terminal 310.

To report on metrics and provide feedback to advertisers and content providers, Advertisement tailoring system 412 may report information from Advertisement Results 417 as appropriate. The content with advertisements placed by valuation is directed to Output subsystems 418, which may include but are not limited to, television monitors, radios, computer monitors, PDA's, computer projectors, emails, cell phone screens, phone screens.

FIG. 5 illustrates the detailed components of the Advertisement Tailoring system 412 which may include real time decisioning and placement of valued and tailored advertisements in content. In one embodiment, advertisements are received ahead of content delivery, valued, processed and stored by the Advertising Tailoring System 412

In another embodiment, tailored advertisements are stored locally but not directly within the Advertising Tailoring System 412. An example where this may be appropriate would be when a set-top box is retrofitted to implement an embodiment, but said set-top box does not have the significant amounts of memory needed to store full motion video advertisements. In this case, storage of advertisements may be on multi-media computer that has a connection to the Advertising Tailoring System 412. When the advertisement selection is triggered by a time code or a q-tone, the advertisement is fed to the Advertising Tailoring System 412 for placement in the program.

One embodiment addresses the situation when space or storage constraints limit the ability to store the advertisements locally on the Advertising Tailoring System 412. In this embodiment, appropriate advertisements are not transmitted and stored prior to content delivery. Instead the advertisements are stored remotely. Advertising Tailoring System 412 creates tailored valuations and then feeds the appropriate advertisements to a remote location for placement in content. In this manner content and tailored advertisements are delivered together to the user. To the end user this method would appear quite similar to traditional models of content delivery, with the major exception that the advertisements in the delivered content would be uniquely tailored to the individual user receiving the content.

FIG. 5 is a block diagram illustrating an exemplary Advertising Tailoring System 412, consistent with the principles of the present invention. Advertising Tailoring System 412 may be any general-purpose computing system using Linux, Unix, Windows, Apple or any operating system In any case, such a system may have at least one Input Device 521 which may include network interfaces, keyboards, mice, speech recognition devices, or document, video, or image input devices remote control devices, a broadcast input interface, a satellite input interface, a cable TV input interface. Additionally, Advertising Tailoring System 412 may have at least one output device 623, such as, display devices, network interfaces, printers, or sound or speech output devices.

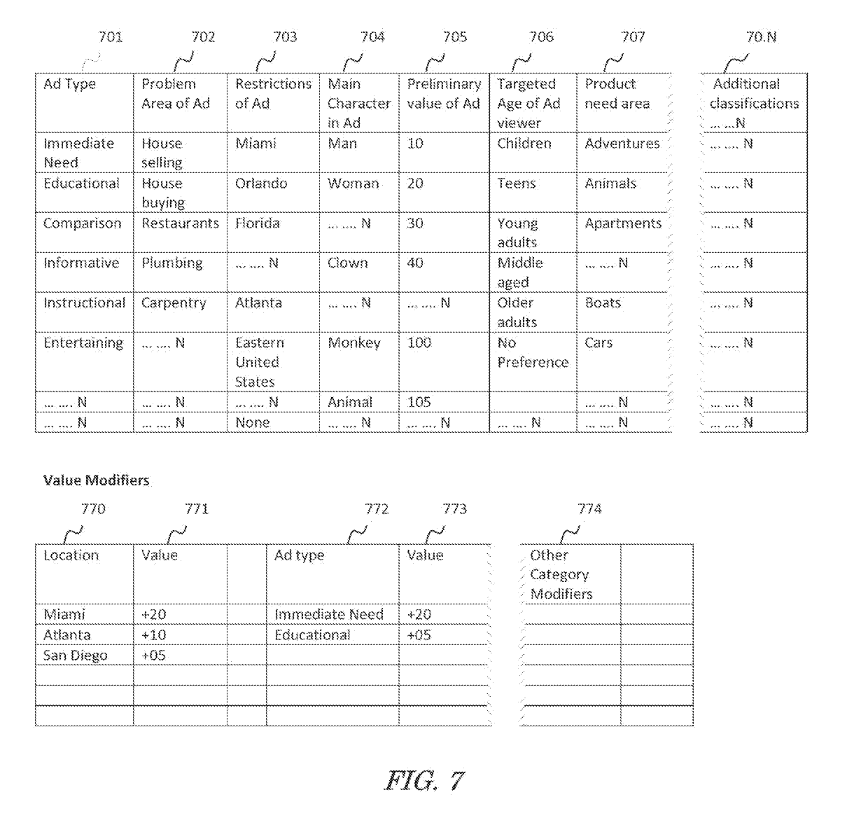

At least one central processing unit (“CPU”) 522 will be used in Advertising Tailoring System 412. CPU 522 may execute software programs for implementing the processes described below with respect to FIGS. 7-18. One skilled in the art will appreciate that although FIG. 5 shows one CPU, multiple CPUs may execute the Ad Valuation Module 524 and the Ad Placement Module 525, along with the Database Software 526, and Database tables 527. The Ad Valuation Module 524 processes the various inputs, determines the individual value of potential advertisements, and then places advertisements in appropriate categories relating to the user's preferences, such as high value, medium value, and low value. The invention's categorization grouping is unlimited and advertisements may even be categorized by the advertisement's unique discreet calculated valuation, (i.e. Ad1=107, Ad2=103, Ad3=103, Ad4=102, Ad5=99, etc.).

As a user selects content, the Ad Placement Module 525 evaluates a content program which may be in real time, and then places an appropriately valued advertisement in an appropriate advertising slot.

Memory 529 may also contain Advertisement Measures Module 528, which may process advertisement placement details such as date and time of placement, final tailored valuation, customer's ratings, and any customer information that is voluntarily given. Advertisement Measures Module 528 may also consolidate results and calculate advertising measures as needed to provide adequate feedback to users, advertisers, advertising agencies and content providers. These software programs may reside in Memory 529 of advertisement tailoring system 412. In addition, Memory 529 may include Database Tables 527 comprising records, such as, individual advertisement preferences, previously highly valued advertisement descriptions, account transaction records, etc. . . . Also Memory 529 may include Database Software 526 for manipulating the records of Database Tables 527.

Stored Advertisements 530 may be included in the Memory 529 of Advertisement Tailoring System 412. As mentioned above, one embodiment facilitates the placement of advertisement within content. Advertisements may be stored locally on a hard drive. Since, in this illustrative example, advertisements used by Ad Placement Module 525 reside locally, response times may be kept to a minimum.

In addition, to facilitate operation this invention envision, advertisements may be sent using Input Subsystems 410 (FIG. 4) to the Stored Advertisements 530 during non-peak times and low content utilization times such as overnight. This may have the effect of decreasing the bandwidth need for delivering content and advertisements at the same time.

In one embodiment, stored Advertisements 530 may even contain different advertisements for different system users. For example, a husband may hand over a Remote Control 320 (FIG. 3) to his wife in the middle of program and leave the room. His wife may select her viewer number from the Remote Control 320, which would then switch the Ad Placement module 525 to her preferred stored advertisements 530. Immediately, the Advertisement Tailoring System 412 will begin placing advertisements that meet the wife's valuation preferences in appropriate commercial breaks within the content.

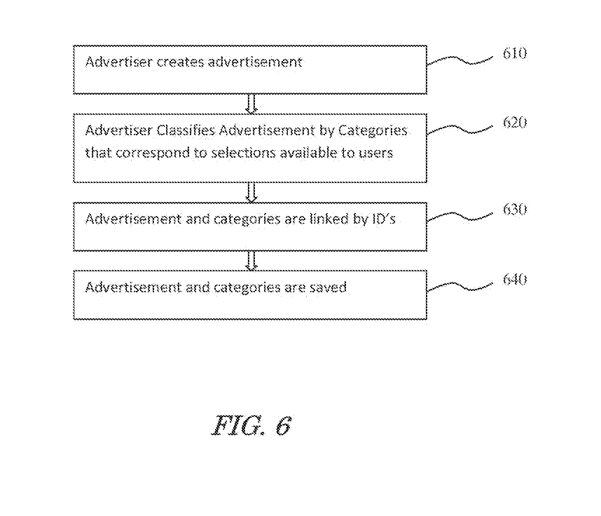

FIG. 6 illustrates an exemplary process for classifying advertisements by shared referenced attributes consistent with this invention. A single item may have a plurality of classifications, and a plurality of attributes the content of which corresponds with attributes or preferences available for users to select. An advertisement is created 610 by an advertiser or his agent in any format, or combination of formats, including but not limited to, video, audio, graphics, text. During, or after, creation of the advertisement, the advertiser or his agent classifies, identifies and classifies 620 properties or attributes of the advertisement that accurately describe said advertisement from a list of referencable attributes and properties. The advertisement is assigned an Identification (ID) 630 number and the various classifications are linked to said advertisement's ID. The advertisement's ID may be numeric, alphanumeric or any other form of identification. The advertisement and categories are saved and may be stored in any type of database in any format.

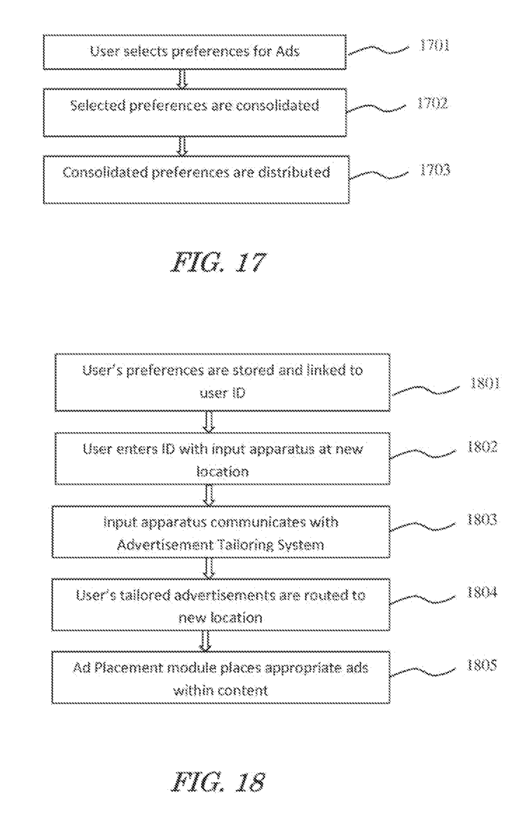

FIG. 7 illustrates an exemplary table that may be used for the classification of advertisement. This example is illustrative and not meant to be limiting of the invention. Throughout the figure the symbol″ . . . . . . N″ is used to denote that additional potential selections exist and the table should not be viewed as restrictive nor comprehensive with regards to the invention. AD type 701 allows categorization for the overall type of the advertisement. Problem Area of Ad 702 allows categorization of the user or consumer problem that an advertiser is trying to solve. Restrictions of Ad 703 allows the advertiser to tailor advertisements to geographic regions. For example, if an advertisement is for a restaurant that is only located in Miami, Fla., an advertiser could restrict that advertisement to Miami. Likewise, for example, if an advertisement needs to be placed nationally an advertiser could select “None” in this category. Main Character in Ad 704 allows the advertiser to identify the main character in the advertisement. For example, from user feedback the advertiser could determine (FIG. 17 to be discussed later) that, advertisements with monkey main characters are especially requested. This allows the advertiser to so denote his inclusion of a Monkey as the main character in the advertisement, thereby increasing the advertisement potential to be viewed. Preliminary value of Ad 705 allows the advertiser to assign a preliminary value to the advertisement. This value is used to determine how much content the advertisement will pay for. As an example, an advertiser with a brand new product on the market may want to set this number high to encourage viewing of his advertisement. Values may also be modified by the advertiser based on criteria. For example an advertiser may want to modify the value based on the user's geographic area, Location 770, and the Ad type 772. In this example, the advertiser wants to increase the ad value 771 in “Miami” by 20, “Atlanta” by 10 and “San Diego” by 5. In all other areas a value increase is not assigned. In this manner the advertiser hopes that the advertisement will be more successful in Miami, Atlanta, and San Diego.

The advertiser may increase the potential value of the advertisement in an unlimited number of ways. For example, if the advertiser wants to attract customers with an immediate need, the advertiser may increase the value to users with certain Ad Type 772 selections. In our example, the advertiser is willing to increase the value 773 for users who express an “Immediate Need” by 20, and increase the value to those that have an “Educational” need by 5. Other Category Modifiers 774 are also envisioned by this invention.

Using Targeted Age of Ad viewer 706 the advertiser may also select the advertisement's original target age group. Product Need Area 707 allows the advertiser to classify the advertisement's product or service. This categorization is especially helpful for users who have a desire to learn about a specific group of products. For example, a person transferring to Washington D.C. may want to learn about potential apartments in the metro area and this category selection would be very important. Additional classifications . . . . . . N 70.N denotes that advertisements may be categorized into a plurality of additional different groups, which for the sake of brevity are not identified here, and yet are still within the scope of this invention.

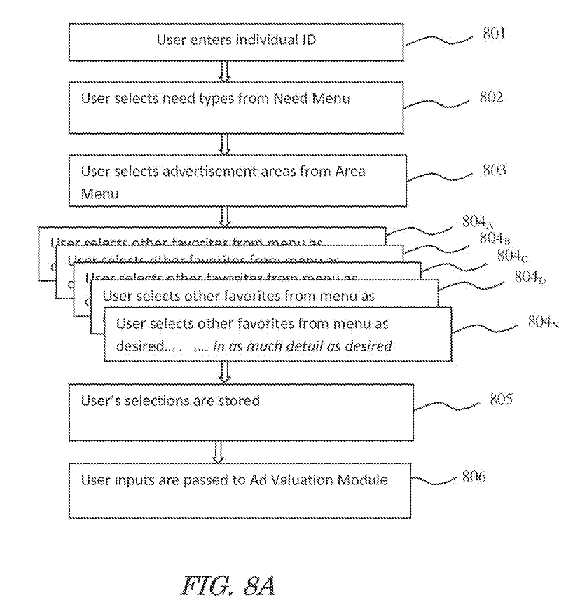

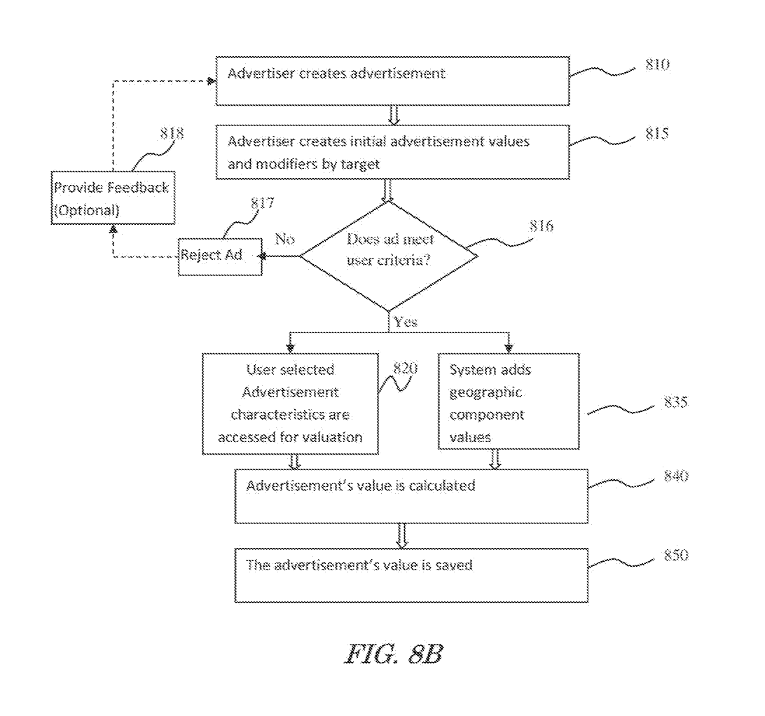

FIG. 8A illustrates an exemplary process gathering user input for valuing advertisements consistent with the invention. The user enters an identification number 801 using a data entry device, which may include but is not limited to, a keyboard, a mouse, a remote control device, a phone key pad, a voice recognition unit, a game controller or any other method that facilitates entry of information or selection from menus into the invention. One embodiment may include entry through a remote control device. This ID entry will help differentiate users of the invention within a single household. For example, an ID 801 selection that will apply to all members of a household may be the number 0 which may be selected from the remote control device. In addition, a husband in a family may select the number 1 from the remote control keypad to differentiate his selections. His wife may select the number 2 from the remote control keypad to differentiate her selections. The oldest child in the family may select the number 3 from the remote control keypad to differentiate her selections and so forth. In one embodiment, after entering the user ID, the user may select the need type from the Need Menu 802. This selection allows the user to inform the system that the user may have an urgent need for advertisements on a special topic, or to solve a special problem, additional potential selections in this area may communicate the broad type of advertisement for which the user has interest. These may include, but are not limited to, communicating a need for Educational, Instructional, Informative, Comparative or even Entertaining advertisements. Generally, the user will make at least one more selection when setting up advertisement preferences, although if a user selected something like “Entertaining” advertisements in 802 that may be all that is necessary for the user to select. When a user wants to more directly tailor his advertisement selections he or she may make at least one selection form the Area Menu. This menu may contain the potential areas of interest by the user or even the potential problems that the user is trying to solve. An example of selections, that are not intended to be comprehensive may include: Apartments, Babies, Boats, Cars, Food, Gardens, Houses, Jobs, Personal Care, Professionals to hire, and so forth.

The user continues to make selections through various menus 804_{A}, 804_{B}, 804_{C}, 804_{D} . . . 804_{N} to create as detailed an advertising profile as the user desires. Additional selection menus may include but are not limited to: Geographic areas; Initial Valuations of ads by advertisers, such as High value, Low Value, etc.; Main Character in ad, such as men, women, animals, monkeys, cartoons, etc.; Languages of Ads, such as Chinese, Spanish, French; Age Segments such as Children, Teen, etc.; product Brand Name; and so forth.

In addition to positive selections, negative selections are also consistent with the invention. A user may not want to receive an advertisement for products or services of a certain type or even brand. For example, a user may not want to receive any advertisements for on Erectile Dysfunction or ED. An ED advertisement may be classified as entertaining, but because of the user's negative selection the ED advertisement may be blocked within the system and method.

Once a selection is made, the selection is stored 805 in any appropriate format. Consistent with the present invention, these selections may be stored in Database Tables 527 (FIG. 5). As advertisements are evaluated (FIG. 8B) user criteria and preferences are passed 806 to the Ad Valuation Module as needed.

FIG. 8B illustrates an exemplary process for valuing advertisements consistent with the invention. This process utilizes the Ad Valuation Module 534 in FIG. 5. After an advertiser creates and advertisement 810, the advertiser creates the initial advertisement values and modifiers by target 815 that were described in FIG. 7 above. The Advertising Tailoring System 412 (FIG. 4) checks to determine 816 whether or not the advertisement being reviewed has characteristics that are interesting or important to the user. If the characteristics of the advertisement meet at least one of the positive criteria of the user, and do not contain negative selections, (FIG. 8A details the selection process) the advertisement may continue in the process. If the advertisement does not meet at least one of the criteria of the user (FIG. 8A) the advertisement is rejected. Further embodiments may also provide feedback 818 to the advertiser. This feedback should be able to help the advertiser create more tailored, and more highly valued advertisements for users.

Advertisements that make it through the screening criteria will continue in the process. User's input 820 may now be accessed for tailoring the advertisement's Valuation. The process may add geographic component values 835 to the process. Location input is optional but is part of one embodiment because it helps allow advertising valuations and advertisement placement to be more accurately tailored to local conditions and local advertising specials. The geographic information may come from a number of sources. In one embodiment the geographic information comes from satellite or cable billing zip codes that are linked to the set-top box by the set-top box's identification number. In another embodiment the zip code is entered by the user when the Advertisement tailoring Receiver/Decoder 360 (FIG. 3) is set up for the first time. This may even include zip code +4 location codes (approximately 10 households are in Zip+4 locations).

Advertisement's value is calculated 840 using a formulae that comprises the preliminary advertiser inputs 820, the user selections 830 and may include the geographic values 835. Once a calculation is made the new advertisement's value may be saved 850.

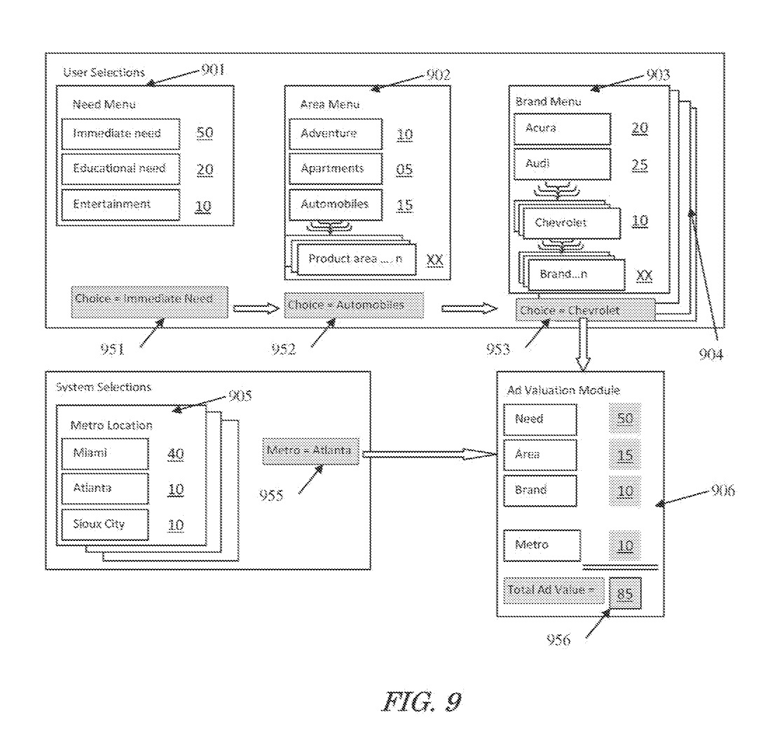

FIG. 9 is an illustrative example to demonstrate a valuation for an advertisement. For this example, assume that the user is urgently interested in finding a new car, and that he is especially interested in what Chevrolet has to offer. From the Need Menu 901, the user's choice 951 selected: “Immediate Need” to denote that the user is interested in advertisements and will likely be buying soon. From the Area Menu 902 the user's choice 952 selected: “Automobiles”, the system intelligently lists the current brands of automobiles to allow the user to select a brand from Brand Menu 903. User's choice 953 selected: “Chevrolet” from the menu. The user could continue to make more selections 904, but because of his immediate need he concludes this selection. The Advertising Tailoring system 412 system extracts the user's zip code, which for one example is 30042, and determines that zip code, from Metro Location 905, is the Atlanta Metro area. Metro =Atlanta 955 is selected. The values gathered from all of these selections are totaled in the Ad Valuation Module 906 to arrive at the Total Ad Value 956 of 85. In this example, for illustrative purposes, addition was used to establish the advertisement's value. Advertisement valuation calculations may also include subtraction, multiplication, and division or any combination of these.

Once the advertisement value is derived, the resulting valuation is used to categorize advertisement for placement in content. FIG. 10 is and illustrative example consistent with the present invention. Ad Placement Module 525 (FIG. 5) comprises A Premier Value Module M1 1000, a Mid-Value Module M2 1010, and a Low Value Module M3 1020, This Ad Placement Module is scalable and could contain more or fewer valuation modules as seen by N . . . Module M_{N}. 1030 Valuation Advertisement valuations are populated into modules of similarly valued advertisements. For this example, and for illustrative purposes only, assume advertisements with values greater than 100 may be placed in the Premier Value Module M1 1000. Advertisements with values between 50 and 100 inclusive may be placed Mid-Value Module M2 1010. Advertisements with values less than 50 may be placed in Low Value Module M3 1020.

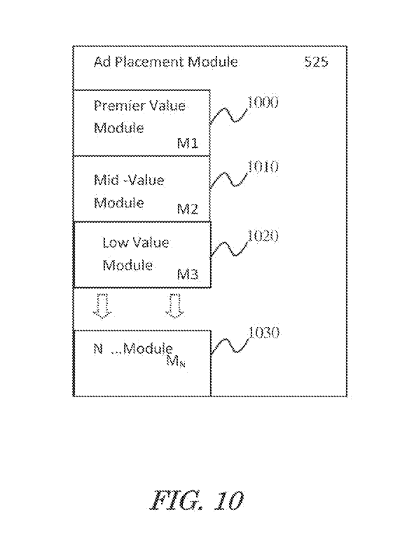

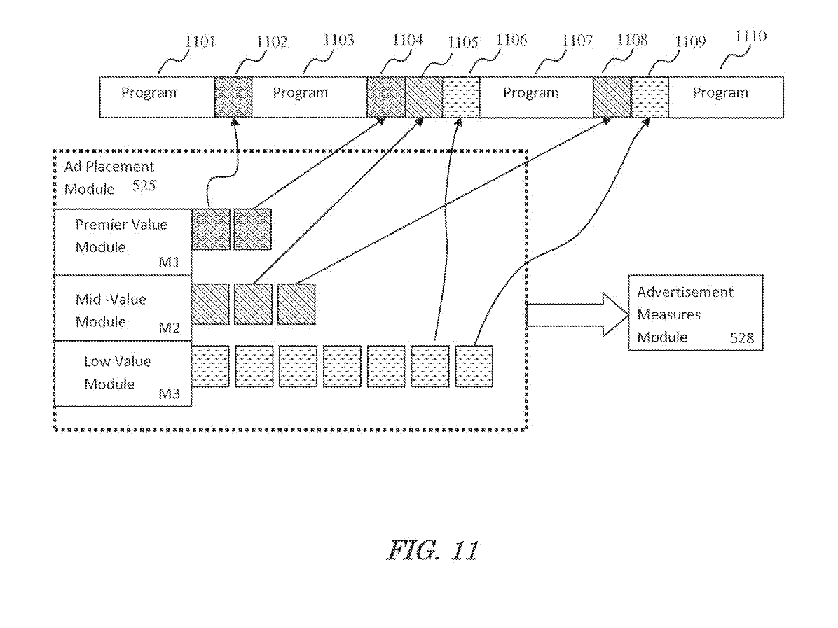

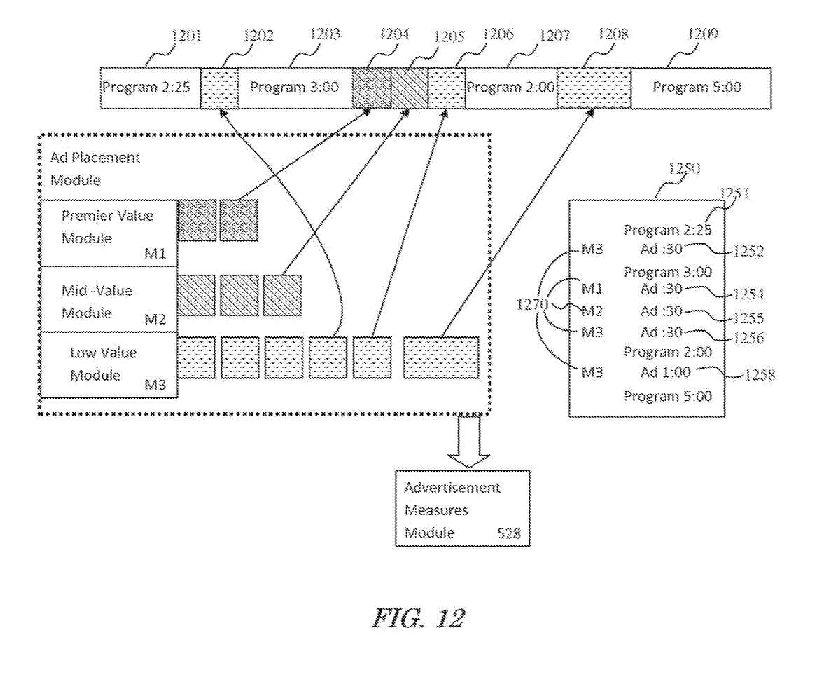

FIG. 11 is an illustrative example consistent with the innovation which demonstrates how a Higher Value program may receive ad placement from the Ad Placement Module 525. Initial program content 1101 is received through the Advertising Tailoring System 412 (FIG. 4). Ad Placement Module 525 identifies that commercial break 1102 requires a premier value commercial, then selects a commercial from the Premier Value Module M1, places it at 1102 and then passes the placement information which may include date, time, final value of advertisement, etc. to the Advertisement Measurement Module 528 (from FIG. 5). Placement of advertisements can be triggered by time codes or q-tones, or other methods. Advertisement placement requests may be attached to the specific content that is received into the Advertising Tailoring System 412 (FIG. 4). Content provider may send the Advertising Tailoring System 412 a summary of advertisement placement locations and valuations along with content. Advertisement placement requests may be sent simultaneously with content or may be sent prior to delivery of the content. Both methods give the Advertising Tailoring System 412 the ability to look ahead and identify advertisements needed to support content. (FIG. 12)

After the first Premier Value advertisement has concluded, the content program 1103 resumes. In this example the next advertisement needed is also a Premier Value advertisement 1104. Ad Placement Module 525 identifies the required value, selects a commercial from the Premier Value Module M1, places it at 1104 and then passes the placement information to the Advertisement Measurement Module 528.

Ad Placement Module 525 determines the next advertisement needed is a Mid-Value advertisement 1105. Ad Placement Module 525 identifies the required value, selects a commercial from the Mid-Value Module M2, places it at 1105 and then passes the placement information to the Advertisement Measurement Module 528.

Ad Placement Module 525 determines the next advertisement needed is a Low Value advertisement 1106. Ad Placement Module 525 identifies the required value, selects a commercial from the Low Value Module M3, places it at 1106 and then passes the placement information to the Advertisement Measurement Module 528. Following Advertisement 1106 is addition content program 1107.

Ad Placement Module 525 determines the next advertisement needed is a Mid-Value advertisement 1108. Ad Placement Module 525 identifies the required value, selects a commercial from the Mid-Value Module M2, places it at 1108 and then passes the placement information to the Advertisement Measurement Module 528.

Ad Placement Module 525 determines the next, and this case final, advertisement needed is a Low Value advertisement 1109. Ad Placement Module 525 identifies the required value, selects a commercial from the Low Value Module M3, places it at 1109 and then passes the placement information to the Advertisement Measurement Module 528. Following Advertisement 1109 is addition content program 1110.

FIG. 12 is an illustrative example consistent with the innovation which demonstrates how a Lower Value program may receive ad placement from the Ad Placement Module 525. In addition, FIG. 12 illustrates how a content provider may communicate program and advertisement information to the Ad Placement Module 525.

In this illustrative example, Communication 1250 is attached to the content program when it is received by the Ad Placement Module. This can be accomplished in a number of ways, including, but not limited to: sending a digital file denoting program times and ad times simultaneously to, or prior to content delivery; sending a plurality of digital files each representing the planned programming for a time period, (i.e. an hour, a block of hours, a day etc.) Said plurality of files may be bundled together or unbundled.

FIG. 12 illustrates a valuable feature of the invention because in this example, the program is being selected in the middle of the program; slightly more than 15 minutes of the program remains. In this illustrative example the program and advertisement queue times are sent simultaneous with the user tuning into the program. Table 1250 illustrates what may be sent to inform the Ad Placement Module of upcoming insertion points. Essentially 1250 is the representation of 1201 through 1209 as seen in another format: a program queue time format. A component is the ad valuation group designation 1270 that the content provider suggested was required to pay for the Initial program content. In addition Program run time 1251 corresponds to 1201, the Ad time 1252 corresponds to 1202, which is then followed by 3:00 minutes of program time, the Ad time 1254 corresponds to 1204, the Ad time 1255 corresponds to 1205, the Ad time 1256 corresponds to 1206, which is then followed by 2:00 minutes of program time, the Ad time 1258 corresponds to 1208, which is then followed by 5:00 minutes of program time,

Program 1201, scheduled to run for 2:25, is received through the Advertising Tailoring System 412 (FIG. 4). Ad Placement Module 525 identifies that commercial break 1202 requires a low value commercial, then selects a commercial from the Low Value Module M3, places it at 1202 and then passes the placement information which may include date, time, final value of advertisement, etc. to the Advertisement Measurement Module 528 (from FIG. 5).

After the first advertisement has concluded the content program 1203 resumes. In this example the content is scheduled to run for 3:00 minutes before the next advertisement will be placed. In this example, the next advertisement needed is also a Premier Value advertisement 1204. Ad Placement Module 525 identifies the required value, selects a commercial from the Premier Value Module M1, places it at 1204 and then passes the placement information to the Advertisement Measurement Module 528.

Ad Placement Module 525 determines the next advertisement needed is a Mid-Value advertisement 1205. Ad Placement Module 525 identifies the required value, selects a commercial from the Mid-Value Module M2, places it at 1205 and then passes the placement information to the Advertisement Measurement Module 528.

Ad Placement Module 525 determines the next advertisement needed is a Low Value advertisement 1206. Ad Placement Module 525 identifies the required value, selects a commercial from the Low Value Module M3, places it at 1206 and then passes the placement information to the Advertisement Measurement Module 528. Following Advertisement 1206 is additional content program 1207. Program 1207 is scheduled to run for 2:00 minutes before the next commercial break.

Ad Placement Module 525 determines the next advertisement needed is a Low Value advertisement 1208. It also determines that the content is recommending 1:00 full minute of Low value Advertisement. Ad Placement Module 525 could place two 30 second Low Value advertisements. Instead, Ad Placement Module 525 identifies that a single 1:00 minute Low Value advertisement is available in Low Value Module M3 and places that at 1208. Ad Placement Module 525 then passes the placement information to the Advertisement Measurement Module 528. Following Advertisement 1208 is addition content program 1209 scheduled to run for 5:00 minutes.

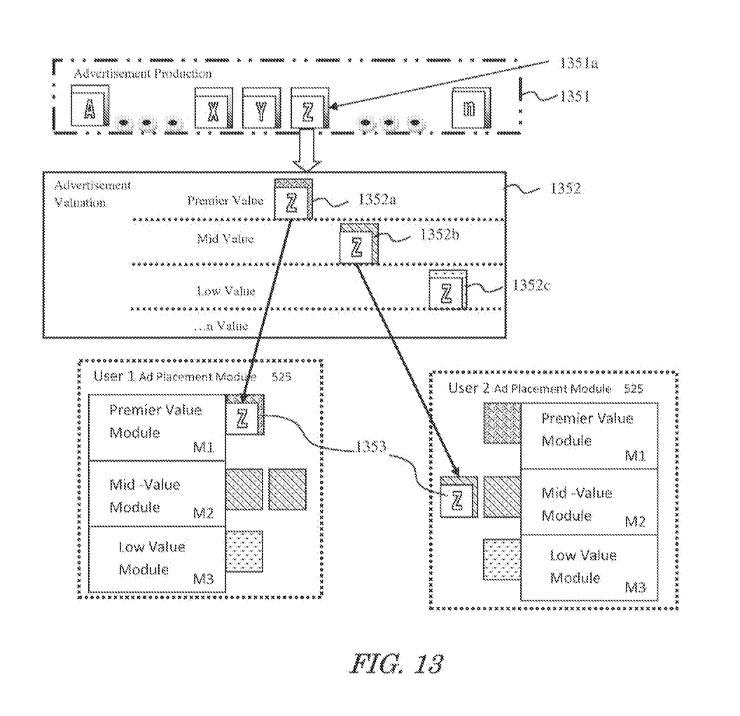

FIG. 13 and FIG. 14 are related to one another. They show important features of the invention and how valuations for an identical advertisement may vary significantly. FIG. 13 presents an illustrative example that is consistent with the system and method that permits an identical advertisement to be valued differently by each of a plurality of users. This is because user preferences affect the final advertisements valuation. The advertisement producer, Advertisement production 1351, creates individual advertisements. Advertisement Z 1351a is produced by the advertisement producer consistent with the process outlined in FIG. 6 (above).

After Valuation 1352 the advertisement may be placed in a plurality of different value categories for a plurality of different users. Premier value 1352a, Mid Value 1352b, Low Value 1352c. are illustrated but the advertisement could be placed in many more categories. In this example the identical advertisement “Z” 1353 is placed in the Premier Value Module M1 for User 1. For user 2, identical advertisement 1353 is placed in the Mid-Value Module M2. The use of such a classification can be seen in FIG. 14.

FIG. 14 presents an illustrative example of an embodiment that is consistent with the system and method that permits an identical advertisement 1353 to be placed in different parts of the identical content program 1401. Identical content program may be received by both users at the same time or at different times. Since the advertisement's valuation (FIG. 13) for user 1 placed the advertisement in Premier Value Module M1 Advertisement 1353 is placed in program 1401 at location 1400 within the program. This is contrasted with User 2's identical advertisement 1353 that, after valuation, (FIG. 13) placed the advertisement in Mid-Value Module M2. As a result, Advertisement 1353 is placed in the third advertising slot 1402 of user 2's received content.

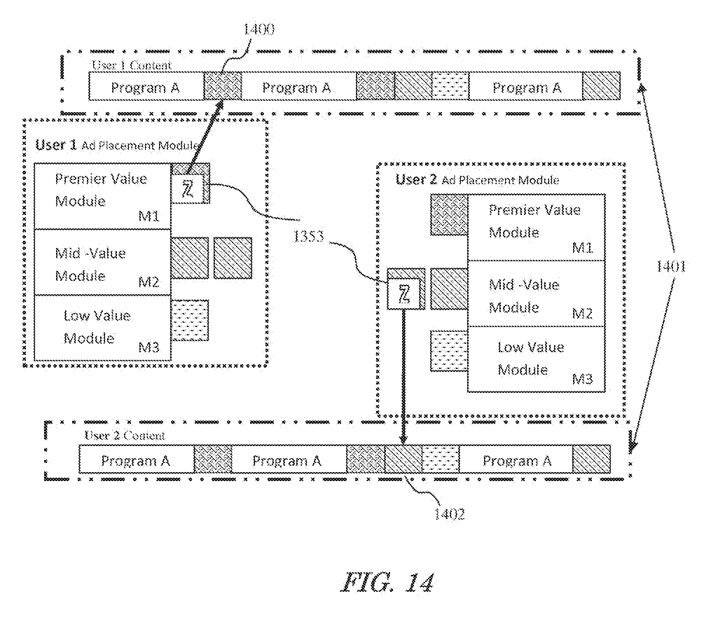

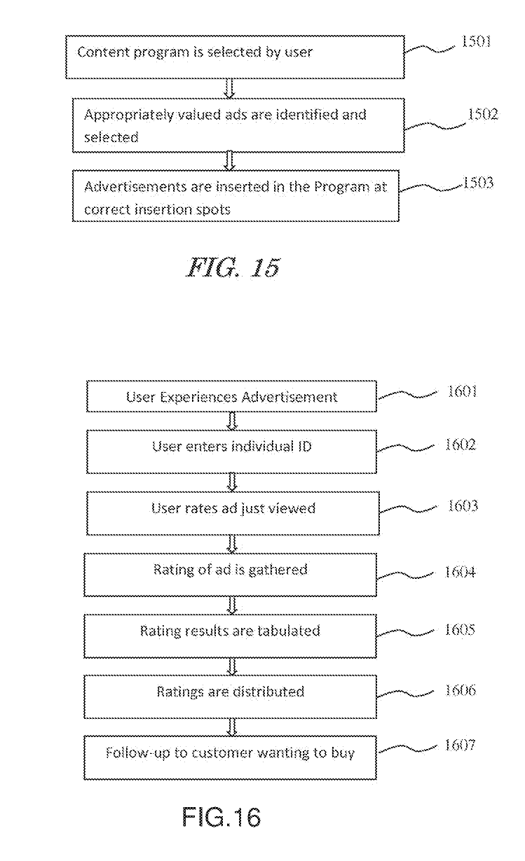

FIG. 15 illustrates an exemplary process for placing advertisements with tailored valuations consistent with this invention. Content Program 1501 is selected by user. Next, the appropriately valued advertisements are identified and selected for the program. This selection may be done in real time. Advertisements 1503 are inserted into the program at the correctly valued insertions spots. FIGS. 11, 12, and 14 are illustrations of this placement that is consistent with the invention.

FIG. 16 illustrates an exemplary process that allows users to rate previously valued and placed advertisements. The user experiences 1601 advertisement within content. At this point the user may enter his or her individual ID 1602. This may be done to later facilitate user initiated contact with the advertiser. Next, the User rates the advertisement 1603. User may rate the advertisement using a data entry device, which may include but is not limited to, a keyboard, a mouse, a remote control device, a phone key pad, a voice recognition unit, a game controller or any other method that facilitates entry of information or selection from menus into the invention. One embodiment may include entry through a remote control device. For example, this rating may be as simple as pressing the remote control number pad after the advertisement is run. For example, pressing 1 may mean the user did not like the advertisement and it was not effective. Pressing 9 may mean the user loved the advertisement and it was highly effective.

Various embodiments include additional functionality for Remote Control 320 (FIG. 3), or other input devices. For example, pressing 9 followed by a 0 may mean the advertisement was highly effective and the user would like contact from the advertising company. The user's name and address could then be provided directly to the advertiser through the Network 350 to initiate contact. In one embodiment, without user permission, personally identifiable information at the household or individual level may not be tracked by the invention. This safety feature is designed to protect user privacy. In some instances, the user may decide that he wants to share information at the individual or household level. This may occur especially if the user would welcome contact from an advertiser that is highly valued by the user. In instances where the user gives his permission the invention may track detailed personal information.

Some embodiments may gather the rating 1604 using Advertisement Measures Module 528 (FIG. 5). The ratings may be stored in Database Tables 527 (FIG. 5). This rating may also be tabulated and combined 1605 with other ratings of the same advertisement or other advertisements. Ratings may then be distributed 1606 to interested groups or individuals, which may include advertisers, content providers, or even individual users. Advertisers or their agents may then Follow-up 1607 with users indicating a desire for contact from the advertiser. This may provide valuable information to advertisers and content providers. In addition, users have an easy way to initiate contact with an advertiser that may interest them.

FIG. 17 illustrates an exemplary process that allows users to influence advertisers. This process can inform advertisers the types of advertisements in which users have interest. This process builds upon the process outlined in FIG. 8A User Selection Details Process. The User selects preferences 1701 for Advertisements following the process outlined in FIG. 8A. Through communication network 350 (FIG. 3) these preferences are consolidate 1702 by at least one category which may include user zip code, other user volunteered information or other consolidation groups. These consolidated preferences are distributed to interested groups or individuals who may include advertisers, content providers, and other users. In this manner a user may help shape the kind of advertisements that are produced, and may help ensure that future advertisement are even more tailored to user preferences.

FIG. 18 illustrates an exemplary process that allows users to receive individually tailored advertisements at locations other than their home locations. In one embodiment user preferences will be stored at a centralized location such as a content provider's facility, or some other node that is linked to the communication network. This invention also envisions a portable device that the user carries, such as a flash drive, a thumb drive, a cell phone, a personal digital assistant, or even a personal computer that is portable. Any apparatus that is capable of storing information could be enabled to store or transport user advertising preferences.

In one embodiment the user's preferences are stored and linked 1801 to the user's personal ID, which could be digital, numeric or alphanumeric. Upon arrival at the new location the user may enter his ID 1802 with an input device such as a remote control. The input device communicates 1803 with the Advertisement Tailoring System. And informs said system of the user. The user's advertisements are routed to the new location 1804. As content is used, the Ad Placement Module places the appropriate advertisements within content at appropriate places.

For illustrative purposes, the transportability of advertisements in FIG. 18 can be seen in the following embodiment. In our example, a business traveler from Boston must go to Saint Louis for 3 days. Upon his arrival at his hotel room he takes the remote control for the Television that has been appropriately enabled to communicate with the Advertisement Tailoring System which is built into the set top box that is connected to the television with a coaxial cable. The traveler enters his ID code, which in this illustrative case, is a 12 digit number. Upon receiving the ID number the Advertisement Tailoring system requests the User's unique advertising preferences from a central database, and downloads appropriately categorized advertisements to the set top box where, where in this example, the advertisements are stored on memory. This memory could be RAM, a hard disk, and optical disk, or any other method of storing content. This memory may be integrated in the set-top control box. As the user views the television content, advertisements that meet his personal preferences are inserted in the content by the Ad Placement module at appropriate locations.

In another embodiment the user could have stored all of his preferred advertisements on a storage device, such as a thumb drive or a USB flash drive. Or any other storage device that is portable. For our example we will assume it is a USB flash drive. Upon arrival at a new location the user inserts the device into a USB socket attached to a television set, a wall socket or attached to a set-top box. Various embodiments envision the device either being left in the USB socket, or advertisement content may be downloaded from the USB drive directly onto a storage device that is integrated with the television, in either the television itself, a connected wall socket or as part of a set top box. As the user views the television content, advertisements that meet his personal preferences are inserted in the content by the Ad Placement module at appropriate locations.

In yet another embodiment, the user's USB flash drive contains only the user's ID. Upon inserting the drive into the appropriate USB receptacle, for this example on a set top box, only the User's ID is transferred to the Advertisement Tailoring system. Said system requests the User's unique advertising preferences from a central database, and downloads appropriately categorized advertisements to the television or to the set top box where, where in this example, the advertisements may be stored on flash memory or by any other storage device or unit which is integrated in the set-top control box or directly in the television set. As the user views the television content, advertisements that meet his personal preferences are inserted in the content by the Ad Placement module.

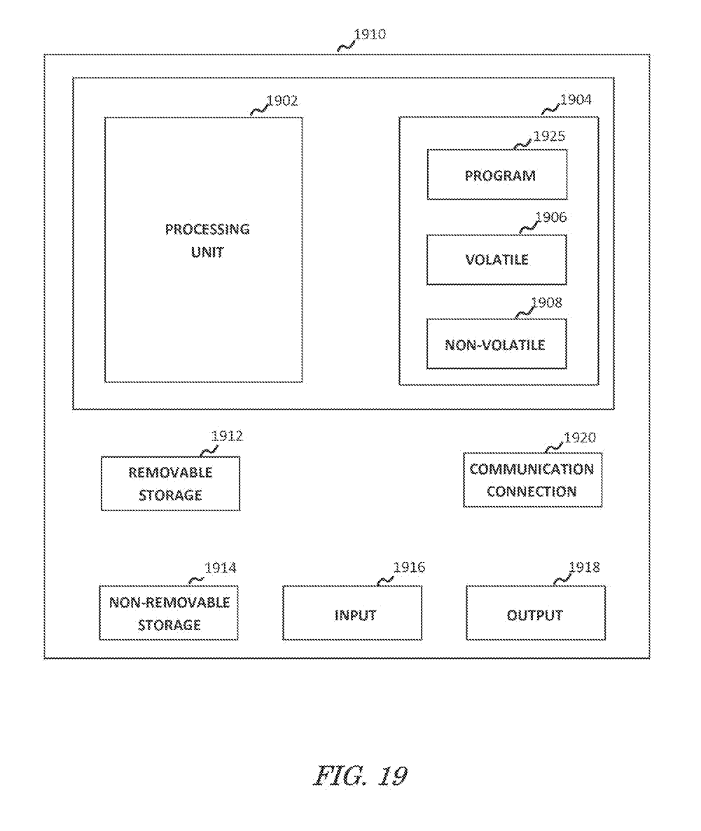

A block diagram of a computer system that executes programming for performing the above algorithm is shown in FIG. 19. A general computing device in the form of a computer 1910, may include a processing unit 1902, memory 1904, removable storage 1912, and non-removable storage 1914. Memory 1904 may include volatile memory 1906 and non-volatile memory 1908. Computer 1910 may include—or have access to a computing environment that includes—a variety of computer-readable media, such as volatile memory 1906 and non-volatile memory 1908, removable storage 1912 and non-removable storage 1914. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1910 may include or have access to a computing environment that includes input 1916, output 1918, and a communication connection 1920. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 1902 of the computer 1910. A hard drive, CD-ROM, and RAM are some examples of articles including a computer-readable medium.

In one embodiment, a system and method pre-match pre-recorded broadcast shows with pre-recorded advertisement and then sends these to individual receivers. In a further embodiment, a system and method matches real time broadcast shows with real time advertisement and then sends these to individual receivers. In an alternative embodiment, a memory stick like device carries an individual's advertising preferences with them. An apparatus may also be provided that allows a user to insert a memory stick with preferences in it into a receiver box, thus enabling it. In yet a further embodiment an apparatus is enabled by a finger print or other suitable biometric component which is linked to a database that will broadcast preferred ads to the receiver. In still a further embodiment, an apparatus allows a consumer to rate the Advertisement after viewing.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A network comprising:
an input apparatus to facilitate at least one classification of at least one advertisement by at least one advertisement attribute or preference;
a provider device to cause a computer system using at least one processor to distribute the at least one classification of the at least one advertisement attribute or preference to the network;
a receiver device to causes the computer system to retrieve the at least one classification of the at least one advertisement;
an advertising classification system using at least one processor that identifies the at least one classification of the at least one advertisement, records the at least one classification, selects and inserts the at least one classification for the at least one advertisement on a storage device such that the classification is provided to the receiver device via a network.

2. An apparatus to provide advertising classification, the apparatus comprising:
an input device that enables a user to select or input at least one classification for at least one attribute or preference of at least one advertisement into an advertising tailoring system;
a processing unit that links a classification of the at least one advertisement to the at least one advertisement as a result of at least one input and that sorts classifications of the at least one advertisement according to defined categories of advertisement attributes and properties which correspond to customer selectable advertising attributes or preferences via a computer using at least one processor; and
a storage device.

3. A computer executed method for classifying at least one advertisement based on advertisement attributes and properties which correspond to customer selectable advertising attributes or preferences, the method comprising:
receiving at least one advertisement;
reviewing the content of the at least one advertisement;
classifying the at least one advertisement by at least one classification said classification being based on predefined advertisement attributes and properties via a computer system using at least one processor;
linking the at least one advertisement and the at least one classification using alphanumeric or digital codes via the computer system; and
storing, on a storage device, the at least one advertisement and the linked codes such that the advertisement and linked codes are accessible to at least one customer selecting advertising attributes or preferences.

4. A method of claim 3 wherein the at least one classification is based on product category.

5. A method of claim 3 wherein the at least one classification is based on the spokesperson in the advertisement.

6. A method of claim 3 wherein the at least one classification is based on parental rating guidelines.

7. A method of claim 3 wherein the at least one classification is based on the sponsor of the advertisement.

8. A method of claim 3 wherein the at least one classification is based on the ideological orientation of the advertisement.

9. A method of claim 3 wherein the at least one classification is based on the presentation of violence in the advertisement.

10. A method of claim 3 wherein the at least one classification is based on the presentation of sexual content in the advertisement.

11. A computer executed method for classifying and distributing at least one advertisement so that access to the advertisement is restricted to meet individual customer advertising preferences and negative selection preferences, the method comprising:
classifying the at least one advertisement by at least one criteria via a computer system using at least one processor;
recording the at least one criteria for the at least one advertisement on a storage device; and
restricting the distribution of the advertisement to meet at least one customer user's individual customer advertising preferences using the at least one criteria via the computer system.

12. A computer executed method for classifying and distributing advertisements tailored to at least one new user to meet the at least one new user's individual customer advertising preferences, the method comprising:
identifying at least one new user to the system from an input apparatus;
identifying at least one new advertisement with previously classified advertisement attributes and properties which correspond to the at least one new user's advertising attributes or preferences via a computer system using at least one processor;
selecting the at least one new advertisement for the at least one new user using the at least one new user's individual customer advertising preferences via the computer system; and
inserting the at least one new advertisement within provided content via the computer system, such that the presentation device performs the at least one new advertisement within the provided content for the at least one new user.
